(19) United States
(12) Patent Application Publication
(10) Pub. No.: US 2026/0023219 A1
(43) Pub. Date: Jan. 22, 2026

(54) TAPERED STRUCTURES FOR LOW TRANSMISSION LOSS

(71) Applicant: Taiwan Semiconductor Manufacturing Co., Ltd., Hsinchu (TW)

(72) Inventors: Tai-Chun Huang, New Taipei City (TW); Stefan Rusu, Sunnyvale, CA (US)

(21) Appl. No.: 18/778,755

(22) Filed: Jul. 19, 2024

(51) Int. Cl. G02B 6/30; G02B 6/12; G02B 6/122; G02B 6/124; G02B 6/132; G02B 6/136

(52) U.S. Cl. CPC G02B 6/305; G02B 6/1228; G02B 6/124; G02B 6/132; G02B 6/136; G02B 2006/12147

(57) ABSTRACT

A method of forming an optical device that includes forming an optical signal coupling material layer including at least one set of gratings on a cladding layer, and patterning the optical signal coupling material layer to provide a geometry including a grating structure including the at least one set of gratings and a waveguide. The transition region includes a curved sidewall is present between the grating structure and the waveguide. In some embodiments, the curved sidewall of the transition region is a concave curvature. In some embodiments, the curved sidewall is a convex curvature.

### BACKGROUND

Electrical signaling and processing is one technique for signal transmission and processing. Optical signaling and processing have been used in increasingly more applications in recent years, particularly due to the use of optical fiber-related applications for signal transmission.

An optical device can provide for the coupling of optical signals from an optical fiber to an optical waveguide for use in optical signaling and processing systems. The efficiency of optical coupling has gradually improved, making the design of tapers relevant to advancing optical signal transmission. However, improvements are desired.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a side cross-sectional view illustrating an interposer used in a method for forming a photonics platform, in accordance with some embodiments.

FIG. 2 is a side cross-sectional view illustrating processing the interposer to provide first optical devices, in accordance with some embodiments.

FIG. 2A is a side cross-sectional view illustrating forming masking to isolate a grating coupler portion of the interposer and removing a first insulating layer of the interposer in the grating coupler portion, in accordance with some embodiments.

FIG. 2B is a top down view illustrating a grating coupler structure including a tapered transition having a sidewall with a concave curvature between the grating structure and the waveguide, in accordance with some embodiments.

FIG. 2C is a top down view illustrating a grating coupler structure including a tapered transition having a sidewall with a convex curvature between the grating structure and the waveguide, in accordance with one embodiment of the present disclosure.

FIG. 2D is a side cross-sectional view illustrating forming a mirror layer on the grating coupler portion of the interposer that is depicted in FIG. 2A, and forming a first cladding layer on the mirror layer, in accordance with some embodiments.

FIG. 2E is a side cross-sectional view illustrating etching trenches in a first cladding layer, and depositing a first material layer for a multilayer optical device including a grating structure portion, a waveguide portion and a transition portion, in which the material filling the trenches provides a first set of gratings, in accordance with some embodiments.

FIG. 2F is a top down view illustrating a multilayered grating coupler structure including a first layer having a linear transition between the grating structure portion and the waveguide portion and a second layer having a tapered transition with a concave curvature between the grating structure portion and the waveguide portion, in accordance with some embodiments.

FIG. 2G is a side cross-sectional view illustrating forming a second material layer for a multilayer optical device including a grating structure portion, a waveguide portion and a transition portion, and forming trenches in the second material layer to form a second set of gratings, in accordance with some embodiments.

FIG. 2H is a side cross-sectional view illustrating transmission of optical energy from a first side to a second side of the multilayered grating coupler structure depicted in FIG. 2G, in accordance with some embodiments.

FIG. 2I is a top down view illustrating a multilayered grating coupler structure including a first layer having a tapered transition with a convex curvature between the grating structure portion and the waveguide portion and a second layer with a linear transition between the grating structure portion and the waveguide portion, in accordance with some embodiments.

FIG. 2J is a side cross-sectional view illustrating transmission of optical energy from a first side to a second side of the multilayered grating coupler structure depicted in FIG. 2I, in accordance with some embodiments.

FIG. 2K is a top down view illustrating a multilayered grating coupler structure including a first layer having a tapered transition with a convex curvature between the grating structure portion and the waveguide portion, and a second layer having a tapered transition with a concave curvature between the grating structure portion and the waveguide portion, in accordance with some embodiments.

FIG. 2L is a side cross-sectional view illustrating transmission of optical energy from a first side to the second side of the multilayered grating coupler structure depicted in FIG. 2K, in accordance with some embodiments.

FIGS. 3-9 are side cross-sectional views illustrating the formation of a photonics platform integrating a grating coupler as described in FIGS. 2A-2K, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In some embodiments, the structures and methods described herein provide an optical device structure including a tapered transition between a grating coupler portion and a waveguide portion. However, the embodiments presented herein are intended to be illustrative and are not intended to limit the embodiments to the precise descriptions as discussed. Rather, the embodiments discussed may be incorporated into a wide variety of implementations, and all such implementations are fully intended to be included within the scope of the embodiments.

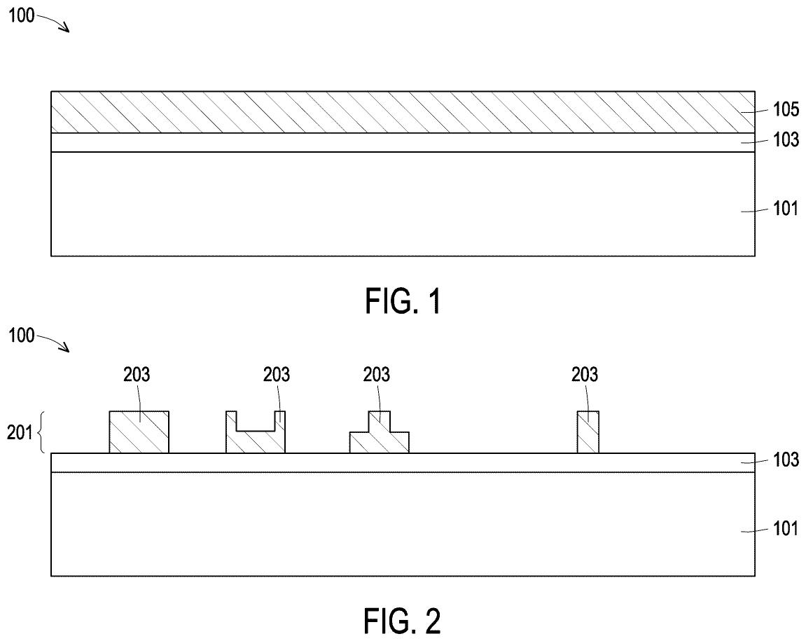

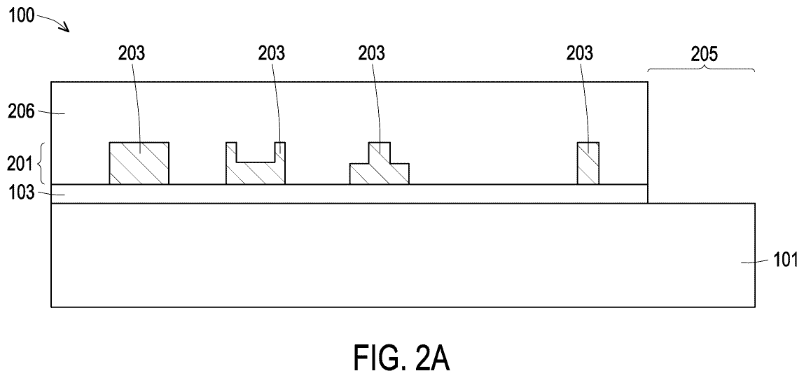

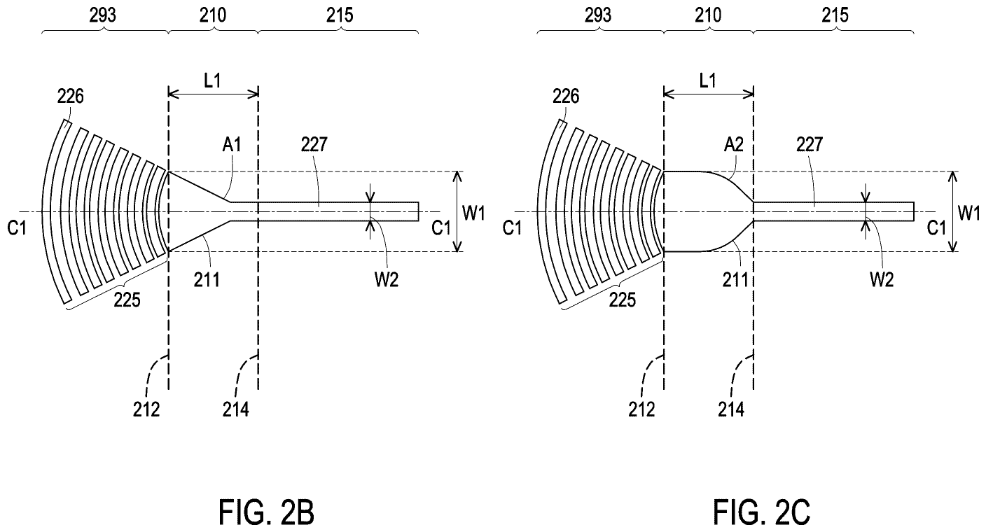

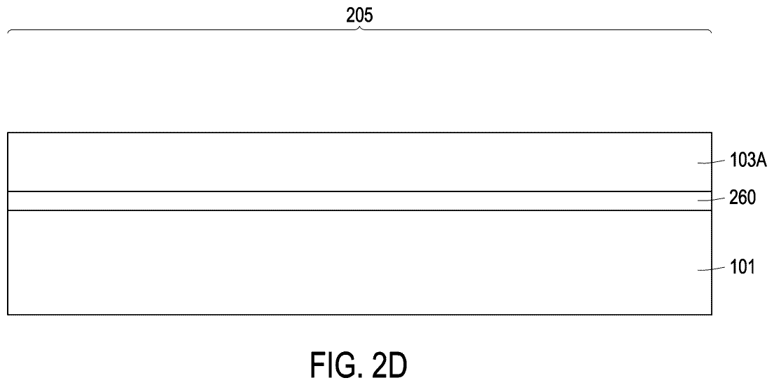

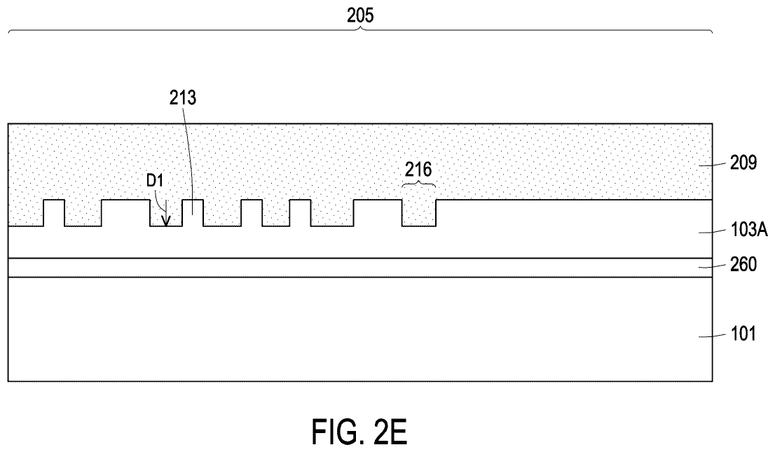

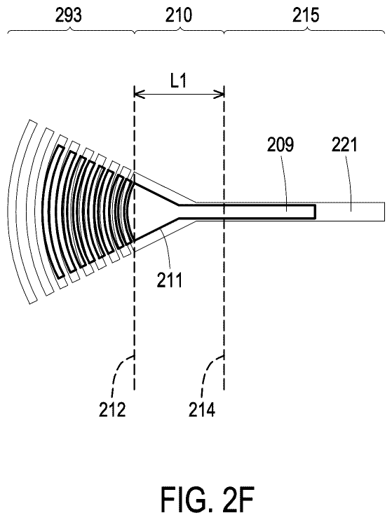

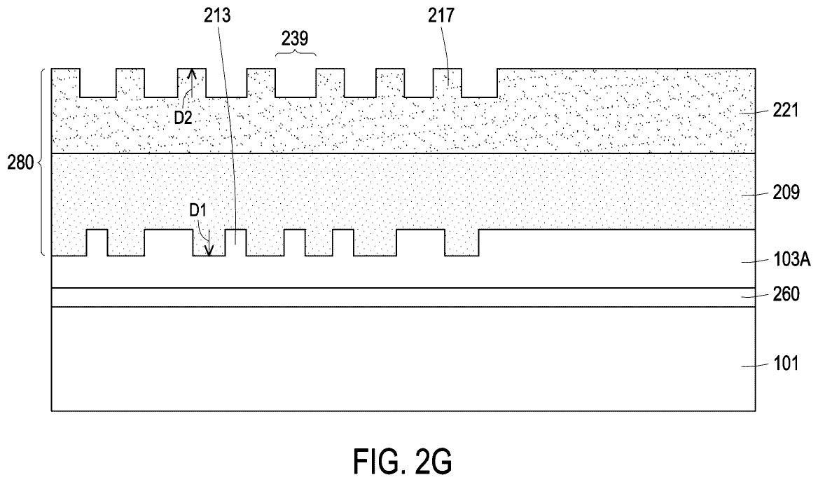

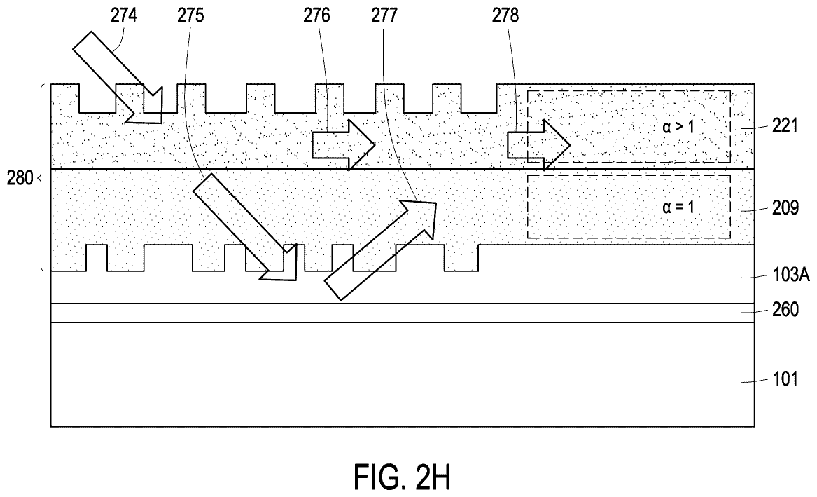

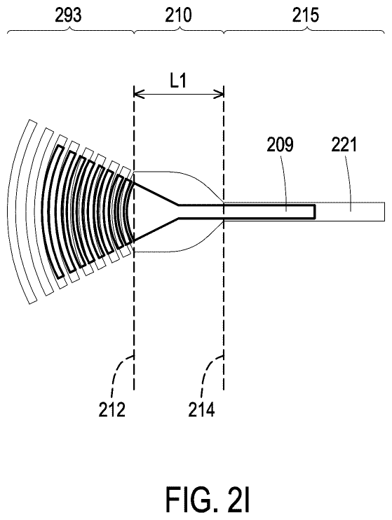

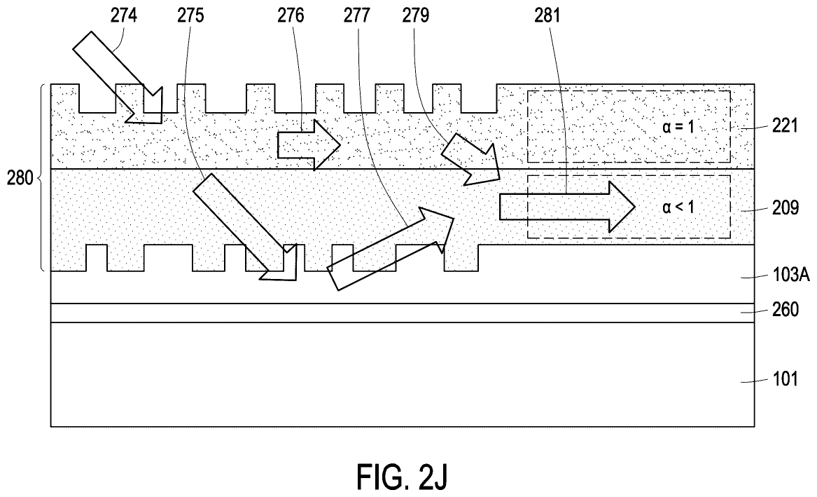

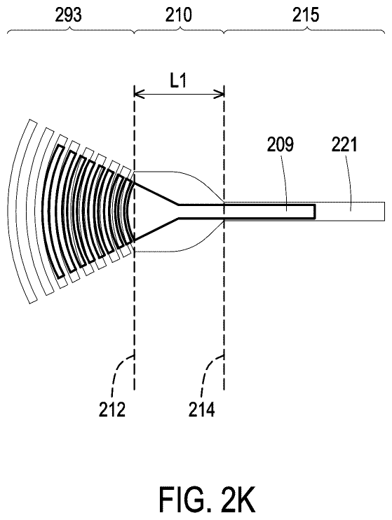

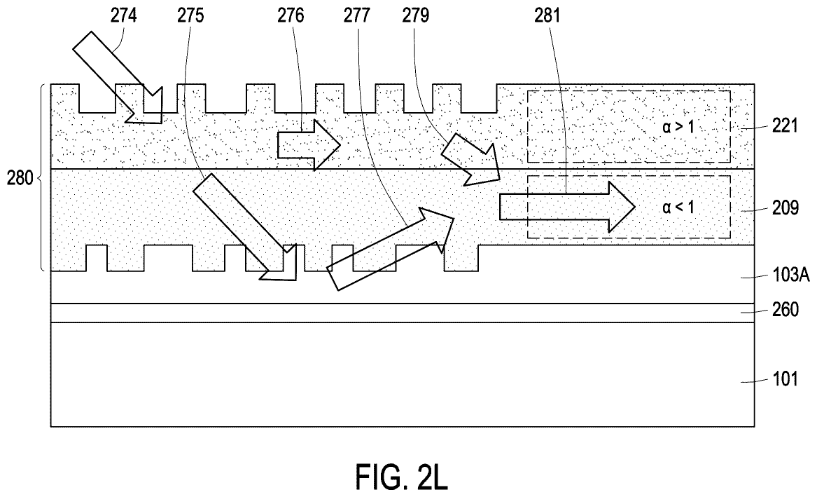

With reference now to FIG. 1, there is illustrated an initial structure of an optical interposer 100. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of the first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment, the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of the first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, the patterning process may be all or at least most of the manufacturing that is used to form these first optical components 203.

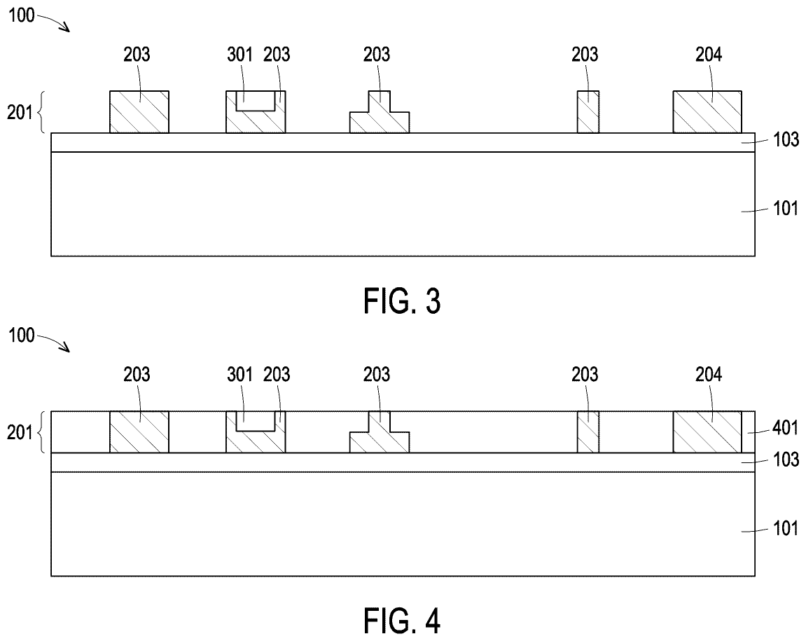

In some embodiments, a portion of the interposer 100 may be processed to provide a grating coupler 204 (as seen in FIG. 3). The portion of the interposer 100 that is processed to provide the grating coupler 204 is hereafter referred to as the grating coupler portion 205 of the interposer 100. In some embodiments, to protect the first optical components 203 during the processing used for forming the grating coupler 204, the portions of the interposer 100 that the first optical components 203 are present in is covered with a masking structure. In some embodiments, the masking structure is patterned to provide that the grating coupler portion 205 of the interposer 100 is exposed. The masking structure which protects the first optical components 203 from the processes used to form the grating coupler 204 may be a hardmask, photoresist mask or a combination of a photoresist mask and hardmask. The masking structure used to isolate the grating coupler portion 205 of the interposer may be removed following completion of the grating coupler 204.

FIG. 2A illustrates one embodiment of forming a first mask 206 to protect the first optical components 203 and expose the grating coupler portion 205 of the interposer 100. Following the formation of the first mask 206, an etch process may be used to remove any portion of the first active layer 105 and the first insulating layer 103 that may be present in the grating coupler portion 205 of the interposer 100. The etch process used at this stage of the process flow may be an anisotropic etch, such as reactive ion etching (RIE). In some embodiments, the etch process that is used to remove the first insulating layer 103 may include an etch chemistry that is selective to the first substrate 101. Following removing the first insulating layer 103, the upper surface of the first substrate 101 may be exposed.

FIG. 2B-2L illustrate embodiments of processing the grating coupler portion 205 of interposer 100 to form a grating coupler 204 including non-linear tapered structures for low transmission loss on silicon photonics platforms. The non-linear tapered structures provide a transition between the gratings and the waveguide interfacing portion of the grating coupler. The tapered transition is a gradually changing waveguide region from a larger size to a smaller size, e.g., a reducing width, which is configured to achieve the optical coupling effect.

FIG. 2B is a top down view illustrating one embodiment of a non-linear tapered transition region 210. Optical signals captured by the grating coupler 204 are affected by gradual dimensional changes during transmission, which can lead to loss and reflection of the optical signals. To effectively reduce these effects, tapers with different curvatures can be used. In the example depicted in FIG. 2B, a grating coupler 204 is illustrated that includes a transition region 210 with a tapered geometry between the grating structure portion 293 and the waveguide portion 215.

FIG. 2B illustrates an embodiment of a transition region 210 having sidewalls 211 with a convex curvature that provides the taper between the grating structure portion 293 and the waveguide portion 215. The taper is the gradual reduction in the width across the length of the transition region 210. The width is the dimension separating the opposing sidewalls 211 of the transition region 210.

More particularly, in some examples, the input side of the transition region 210 abuts the grating structure portion 293 at a first interface 212. The first interface 212 begins at the last grating 226 in the set of gratings 225 for the grating structure portion 293. The first width W1 at the first interface 212 is the greatest width for the transition region 210. The width for the transition region 210 reduces along its length Li to its narrowest point at the exit side of the transition region 210. The exit side of the transition region 210 abuts the waveguide portion 215 at a second interface 214. The second interface 214 is present at the start of the waveguide portion 215. The waveguide portion 215 starts when the opposing sidewalls 227 of the structure following the transition region 210 are parallel to one another. The second width W2 at the second interface 214 is the smallest width for the transition region 210.

FIG. 2B illustrates an embodiment in which the curvature for the opposing sidewalls 211 has a concave curvature. A concave curvature is when the apex A1 of the curvature that defines the geometry of the sidewalls 211 is the closest point of the curve to the centerline C1 of the transition region 210. The curvature (a) for the sidewalls 211 depicted FIG. 2B can also be characterized as being greater than 1, e.g., α>1.

FIG. 2C is a top down view illustrating another embodiment of a grating coupler structure including a transition region 210 having sidewalls with a convex curvature. The transition region 210 depicted in FIG. 2C is another example of a non-linear transition. In the embodiment that is depicted in FIG. 2C the transition region 210 includes sidewalls 211 with a curvature that provides the taper between the grating structure portion 293 and the waveguide portion 215. The taper is the gradual reduction in the width across the length of the transition region 210. For example, the first width W1 at the first interface 212 is the greatest width for the transition region 210. The width for the transition region 210 reduces along at least some of its length Li to its narrowest point at the exit side of the transition region 210. The exit side of the transition region 210 abuts the waveguide portion 215 at a second interface 214. The second interface 214 is present at the start of the waveguide portion 215. The second width W2 at the second interface 214 is the smallest width for the transition region 210.

FIG. 2C illustrates an embodiment in which the curvature for the opposing sidewalls 211 has a convex curvature. A convex curvature is when the apex A2 of the curvature that defines the geometry of the sidewalls 211 is a point of the curve that extends in a direction away from the centerline C1 of the transition region 210, as depicted in FIG. 2C. The curvature (a) for the sidewalls 211 depicted FIG. 2C can also be characterized as being less than 1, e.g., α<1.

The tapered transition regions 210 depicted in FIGS. 2B and 2C, e.g., transition regions having sidewalls 211 with concave curvatures, e.g., α>1, and/or sidewalls 211 with convex curvatures, e.g., α<1, are examples of nonlinear tapered transition structures suitable for the transition region 210 between the grating coupler portion 204 and the waveguide portion 215 of an optical device. The nonlinear tapered structures when employed in the transition regions 210 can be used in silicon photonics platforms, in which low transmission loss is desired. In some embodiments, by integrating the non-linear tapered structures described herein into optical devices, instability of two-dimensional transmission direction optical signals can be reduced. The taper for the sidewalls 211 can be designed and manufactured according to the characteristics and requirements of the waveguide to achieve the best results.

For example, when choosing the curvature of the taper, factors such as the shape and size of the waveguide, the wavelength of light for the optical signals, and the properties of the material need to be considered. In some embodiments, a smoother curvature can reduce reflection and loss of optical signals, but the size of the taper may be larger. In other embodiments, a steeper curvature can reduce the size of the taper, but may result in greater reflection and loss. In some embodiments, the transition region 210 between the grating structure portion 293 and the waveguide portion 215 functions to converge optical signals into the main transmission layer waveguide, e.g., in a multilayered structure.

FIGS. 2D-2H illustrate an embodiment of forming a multilayered grating coupler 204, in which at least one optical signal coupling material layer of the grating coupler 204 includes the non-linear tapered structures illustrated in FIGS. 2B and/or 2C. For the embodiment depicted in FIGS. 2D-2H, the non-linear tapered structure is present in the transition region 210 of the second material layer 221, which is best illustrated by the top down view illustrated in FIGS. 2B and 2F. In some embodiments, the non-linear tapered structure for the transition region 210 is provided by sidewalls 211 that have a concave curvature, as depicted in FIG. 2B. More particularly, the curvature (a) for the sidewalls 211 depicted FIG. 2B can also be characterized as being greater than 1, e.g., α>1.

FIG. 2D illustrates an initial structure that can be used for forming a multilayered grating coupler 204, in which at least one layer of the grating coupler 204 includes the nonlinear tapered structure in the transition region 210. During the processing of the grating coupler portion 205 that is depicted in FIGS. 2D-2I, the remaining portions of the interposer 100 including the first optical components 203 may be protected by one or more block masks and/or hard masks.

FIG. 2D illustrates forming a mirror layer 260 on the grating coupler portion 205 of the interposer 100 that is depicted in FIG. 2A, and forming a first cladding layer 103A on the mirror layer 260.

FIG. 2D illustrates an embodiment of forming a mirror layer 260 on the upper surface of the first substrate 101 that is present in the grating coupler portion 205. The mirror layer 260 may be composed of a metal containing composition material. For example, the mirror layer 260 may be composed of a metal, such as gold (Au), silver (Ag), copper (Cu), tin (Sn), aluminum (Al), tungsten (W), tantalum (Ta), platinum (Pt) and alloys thereof. In some embodiments, forming the mirror layer 260 may begin with depositing a seed layer. For example, the seed layer may comprise a copper layer. The seed layer may be deposited using processes such as sputtering, evaporation, or plasma-enhanced chemical vapor deposition (PECVD), or the like, depending upon the desired materials. The mirror layer 260 may then be plated on the seed layer. The plate metal for the mirror layer 260 may be deposited over the seed layer through a plating process such as electrical or electro-less plating. It is noted that methods and compositions for the mirror layer 260 are provided for illustrative purposes only and are not intended to limit the disclosure to only the material and methods described above. Other compositions and methods for the mirror layer 260 are also within the scope of the present disclosure, so long as the mirror layer 260 being formed is a light reflecting structure. For example, the mirror layer 260 may be formed using backside processing at a later point of the process flow, e.g., following formation of the grating structures. In some embodiments, the mirror layer 260 may be a distributed Bragg reflector (DBR).

FIG. 2D also illustrates forming a first cladding layer 103A on the mirror layer 260. The first cladding layer 103A may be composed of an oxide containing material composition, such as silicon oxide (SiO₂). The first cladding layer 103A may be deposited using a chemical vapor deposition (CVD) process. It is noted that chemical vapor deposition (CVD) is only one example of a deposition process that is suitable for forming the first cladding layer 103A. In other examples, the first cladding layer 103A may be formed using a deposition process, such as atomic layer deposition (ALD) or physical vapor deposition (PVD). Further, the composition of the first cladding layer 103A is not limited to only silicon oxide. For example, in addition to silicon oxide, the first cladding layer 103A may also be composed of silicon nitride, germanium oxide, germanium nitride, and combinations thereof.

FIG. 2E illustrates forming a first material layer 209 for the multilayered optical device. The first material layer 209 may be composed of an optical signal coupling material, e.g., the first material layer 209 may be an optical signal coupling material layer. The first material layer 209 is patterned to include a grating structure portion 293, a waveguide portion 215 and a transition portion 210 (also referred to as transition region), as depicted in FIG. 2F. The transition portion 210 is between the grating structure portion 293 and the waveguide portion 215.

Still referring to FIG. 2E, prior to depositing the first material layer 209, the upper surface of the first cladding layer 103A may be patterned and etched to provide a plurality of trenches 216. In some embodiments, forming the trenches 216 in the first cladding layer 103A includes forming an etch mask (not shown). The etch mask protects portions of the first cladding layer 103A to form the trenches 216. In some embodiments, the etch process for forming the trenches 216 may be a directional etch, such as reactive ion etching (RIE). The trenches 216 that are formed in the first cladding layer 103A are subsequently filled with material from the subsequently formed first material layer 209. In some embodiments, filling the trenches 216 with the material of the first material layer 209 provides the first set of gratings 213. In some embodiments, the trenches 216 may be patterned having a geometry with a curvature and a tapering width so that when filled with the material of the first material layer 209 can provide the first set of gratings 213 having the geometry with a curvature and tapering width towards the waveguide portion 215, which is similar to the geometry of the gratings 225 that is depicted in FIGS. 2B and 2C.

FIG. 2E also illustrates depositing the first material layer 209 for the multilayered optical device. In this embodiment, the material filling the trenches 216 also provides the first set of gratings 213 extending in the first direction D1. The first material layer 209 may be deposited using a deposition method. In some embodiments, the first material layer 209 may be composed of a semiconductor containing material, such as a silicon containing material, e.g., silicon (Si). In some embodiments, the first material layer 209 may be composed of a dielectric material, such as a nitride containing material, e.g., silicon nitride (Si₃N₄).

In some embodiments, the first material layer 209 may be deposited using a chemical vapor deposition (CVD) process, in which the deposition parameters are selected to at least fill the trenches 216 with the material of the first material layer 209. In one example, the chemical vapor deposition (CVD) process may be plasma enhanced chemical vapor deposition (PECVD). In other examples, the first material layer 209 may be deposited using high density plasma chemical vapor deposition (HDPCVD), atomic layer deposition (ALD) or physical vapor deposition (PVD).

As noted the material of the first material layer 209 filling the trenches 216 provides the first set of gratings 213. In some embodiments, the height for the first set of gratings 213 may be adjusted to provide for coupling with different wavelengths of light for the optical signals. In some examples, the height of the first set of gratings 213 may be varied from by changing the etch depth for the trenches 216. To vary the etch depth of the trenches 216, one or more etch masks and etch processes may be applied in which the etch time is varied to vary the different etch depths. In further embodiments, the etch processes may be accompanied with an ion implantation process that can change the etch rate of the material being etched.

Following deposition of the first material layer 209, the first material layer 209 may be patterned and etched to provide the geometry for the grating structure portion 293, the waveguide portion 215 and the transition region 210 between the grating structure portion 293 and the waveguide portion 215, as depicted in FIG. 2F. The etch process may include a masking step and a subtractive etching step.

The etch process for forming the geometry of the grating structure portion 293, the transition region 210 and the waveguide portion 215 can define a sidewall geometry for each of the grating structure portion 293, the transition region 210 and the waveguide portion 215. The sidewall geometry can define the width for each of the grating structure portion 293, the waveguide portion 215 and the transition region 210. For example, the width of the grating structure portion 293 is greater than the width of the waveguide portion 215. In the embodiment depicted being formed in the process flow that is described in FIG. 2D to FIG. 2H, the transition region 210 between the grating structure portion 293 and the waveguide portion 215 in the first material layer 209 is linear.

FIG. 2F is a top down view of yet another embodiment in which the non-linear transition regions are incorporated into a structure in which the first semiconductor layer 209 includes a transition region 210 that is linear. The transition region 210 for the first material layer 209 includes planar sidewalls 211 that do not include a curvature. For example, the planar sidewalls 211 for the transition region 210 of the first material layer 209 can also be characterized as α=1.

To provide the geometry of the first material layer 209 depicted in FIG. 2F, a mask is formed atop the upper surface of the first material layer 209 depicted in FIG. 2E for the multilayered optical device. The mask is patterned in a shape to provide the geometry of the grating structure portion 293, the transition region 210 and the waveguide portion 215 in the first material layer 209. The mask may be composed of a photoresist material, and the mask may be patterned using photolithography and development processes. In some embodiments, the mask structure may also be provided by a hard mask. In some embodiments, the mask for etching the first material layer 209 may be a combination of photoresist masks and hard masks. Following the formation of the mask structure, an anisotropic etch process, such as reactive ion etching (RIE) may be applied to the first material layer 209. The etch process removes the portions of the first material layer 209, in which the portions of the first material layer 209 protected by the etch mask remain to provide the geometry depicted in FIG. 2F.

FIG. 2G illustrates forming a second material layer 221 for a multilayer optical device. The second material layer 221 may be composed of an optical signal coupling material, e.g., the second material layer 221 may be an optical signal coupling material layer. The second material layer 221 may include a grating structure portion 293, a waveguide portion 215 and a transition portion 210, as depicted in FIG. 2F. In some embodiments the transition region 210 of the grating coupler 204 includes the nonlinear tapered structure. More particularly, in the embodiment that is described with reference to FIGS. 2D-2H, the transition portion of the second material layer 221 is configured to include a nonlinear tapered transition region 210, in which the sidewall 211 of the transition region 210 has a concave curvature.

Referring to FIG. 2G, the second material layer 221 can be formed in direct contact with an upper surface of the first material layer 209 using a deposition method. In some embodiments, the second material layer 221 for the multilayered optical device may be composed of a semiconductor containing material, such as a silicon containing material, e.g., silicon (Si). In some embodiments, the second material layer 221 may be composed of a dielectric material, such as a nitride containing material, e.g., silicon nitride (Si₃N₄). In some embodiments, the second material layer 221 may be deposited using a chemical vapor deposition (CVD) process. In one example, the chemical vapor deposition (CVD) process may be plasma enhanced chemical vapor deposition (PECVD). In other examples, the second material layer 221 may be deposited using high density plasma chemical vapor deposition (HDPCVD), atomic layer deposition (ALD) or physical vapor deposition (PVD).

FIG. 2G also illustrates an embodiment of forming a second set of gratings 217 on an upper surface of the second material layer 221. In some embodiments, the second set of gratings 217 may be formed by forming trenches 239 into the upper surface of the second material layer 221. Forming the trenches 239 into the upper surface of the second material layer 221 may include an etch process. For example, the etch process for forming the trenches 239 can include forming an etch mask that is patterned to expose the portions of the second material layer 221 that are to be etched to form the trenches 239. The portions of the second material layer 221 that is protected by the etch mask and between each pair of trenches 239 provide the set of gratings 217 following the etch step that forms the trenches 239. In some embodiments, the etch process for forming the trenches 239 may be an anisotropic etch, e.g., directional etch, such as reactive ion etching (RIE). The second set of gratings 217 depicted in FIG. 2G have a height that extends in a second direction D2 that is opposite the first direction D1 of the first set of gratings 213.

In some embodiments, the depth of the trenches 239 may be adjusted to provide for different grating heights within the first set of gratings 213 for coupling with different wavelengths of light for the optical signal. In some examples, the height of the first set of gratings 217 may be varied from by changing the etch depth for the trenches 239. To vary the etch depth of the trenches 239, one or more etch masks and etch processes may be applied in which the etch time is varied to vary the different etch depths. In further embodiments, the etch processes may be accompanied with an ion implantation that can change the etch rate of the material being etched. In other examples, the height of the gratings may be varied by recessing the upper surfaces of the gratings themselves, which can also be achieved using multiple mask and etch steps.

The first direction D1 for the first set of gratings 213 is opposite the second direction D2 for the second set of gratings 217. In some embodiments, the opposing first and second directions D1, D2 for the first and second set of gratings 213, 217 provide a bidirectional grating coupler structure 280. The first set of gratings 213 that are present in the lower surface of the first material layer 209 are vertically offset from the second set of gratings 217 that are present at the upper surface of the second material layer 221. In some embodiments, the vertical offset of the first set of gratings 213 from the second set of gratings 217 can improve the coupling efficiency of the grating coupler 204. For example, by offsetting the direction and center position of the gratings, the coupling efficiency may be increased, while reducing insertion loss and reflection loss.

In some other embodiments, the distance separating adjacently positioned gratings for the first set of gratings 213, and the second set of gratings 217 may be increased and decreased for coupling with different wavelengths of light for the optical signal. For example, the distance separating adjacently positioned gratings in the first set of gratings 213 may be greater than the distance separating adjacently positioned gratings in the second sets of gratings 217 to provide that the first set of gratings 213 is configured for coupling with broad bands of light for the optical signals.

The second material layer 221 may include a grating structure portion, a waveguide portion and a transition portion. Light being used for optical transmission signals can be affected by gradual dimensional changes during transmission, which can lead to loss and reflection of the optical signals. To effectively reduce these effects, tapers with different curvatures can be used in the transition portion. In some embodiments the transition of the second material layer 221 for the grating coupler 204 includes a nonlinear tapered structure, as depicted in FIG. 2B.

FIG. 2B illustrates an embodiment of a transition region 210 having sidewalls 211 with a curvature that provides the taper between the grating structure portion 293 and the waveguide portion 215. The taper is the gradual reduction in the width across the length of the transition region 210. The non-linear tapered structure for the transition region 210 is provided by sidewalls 211 that have a concave curvature, as depicted in FIG. 2B. More particularly, the curvature (a) for the sidewalls 211 depicted FIG. 2B can also be characterized as being greater than 1, e.g., α>1. The geometry of the transition region 210 depicted in FIG. 2B is etched into the second material layer 221 that is depicted in FIG. 2G.

To provide the geometry depicted in FIG. 2B, a mask is formed atop the upper surface of the second material layer 221 depicted in FIG. 2G for the multilayered optical device, in which the mask has been patterned in a shape to provide the geometry depicted in FIG. 2B. The mask may be composed of a photoresist material, and the mask may be patterned using photolithography and development processes. In some embodiments, the mask structure may also be provided by a hard mask. In some embodiments, the mask for etching the second material layer 221 may be a combination of photoresist masks and hard masks. Following the formation of the mask structure, an anisotropic etch process, such as reactive ion etching (RIE) may be applied to the second material layer 221. The etch process removes the portions of the second material layer 221, in which the portions of the second material layer 221 protected by the etch mask remain to provide the geometry including the non-linear tapered transition region having a concave sidewall curvature that is depicted in FIG. 2B. In some embodiments, the etch mask for etching the second material layer 221 to have the geometry of the grating structure portion 293, the non-linear tapered transition region 210, and the waveguide portion 215.

Returning now to FIG. 2F, FIG. 2F is a top down view illustrating a multilayered grating coupler structure 280 including a first material layer 209 having a transition region 210 that is linear between the grating structure portion 293 and the waveguide portion 215, and a second material layer 221 having a transition region 210 that is tapered with a concave curvature between the grating structure portion 293 and the waveguide portion (215)). The second material layer 221 is present over the first material layer 209, in which the second material layer 221 receives the optical signal before the first material layer 209. The second material layer 221 includes the non-linear tapered transition, in which a portion of the curvature from the transition region 210 is integrated with the grating structure portion 293. The first material layer 209 does not include a curvature for tapering in the transition region 210.

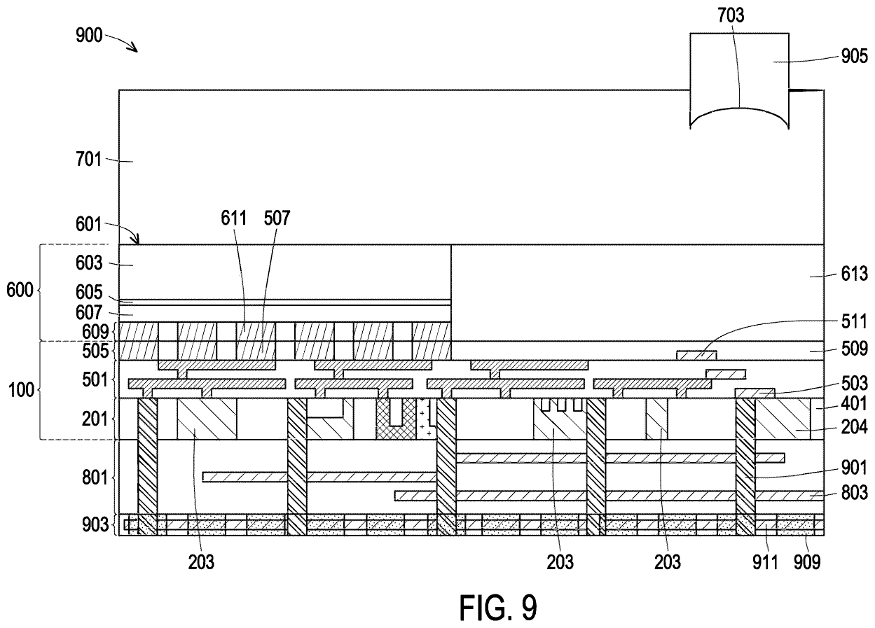

FIG. 2H illustrates transmission of optical energy from a first side to the second side of the multilayered grating coupler structure depicted in FIG. 2H. The optical signal 274 received from an optical fiber 905 (as seen in FIG. 9) is first received by the grating structure of the second material layer 221 of the bidirectional grating coupler structure 280. A portion of the optical signal 274 is coupled with the second material layer 221 in the grating coupler portion and transmitted as first coupled light energy 276. A portion of the optical signal 274 that is not coupled with the second material layer 221 is transmitted to the lower first material layer 209 and/or is reflected off the mirror layer 260 as non-coupled optical signal 275. The non-coupled optical signal 275 may be reflected off the mirror layer 260 as reflected optical signal 277. The reflected optical signal 277 may couple with the second material layer 221. The coupled reflected optical signal 278 may exit the grating coupler portion through the transition region in the second material layer 221. The transition region in the second material layer 221 includes the non-linear tapered transition having a concave sidewalls (α>1), whereas the transition region in the first material layer 221 is linear (α=1). The non-linear tapered transition effectively reduces the transmission losses in waveguide transitions and improves optical coupling efficiency. The reduction in transmission losses and improved coupling efficiency can be apparent when comparing the transition region in the second material layer 221 including the non-linear tapered transition having sidewalls with a concave curvature to the transition region in the first material layer 221 that is linear. The outlet of the first material layer 221 does not include the majority of the light signal between transmitted from the transition region 210 due to transmission loss optical signal can occur therein.

Optical signals are affected by gradual changes during transmission, which can lead to loss and reflection of optical signal. To effectively reduce these effects, tapers with different curvatures can be used. In some embodiments, tapers can be designed and manufactured according to the characteristics and requirements of the waveguide to achieve the best results. When choosing the curvature of the taper, factors such as the shape and size of the waveguide, the wavelength of light for the optical signal, and the properties of the material need to be considered. Generally, a smoother curvature can reduce reflection and loss of optical signal, but the size of the taper may be larger. On the other hand, a steeper curvature can reduce the size of the taper, but may result in greater reflection and loss.

FIGS. 21 and 2J illustrate another embodiment of a multilayered grating coupler 204, in which at least one layer of the grating coupler 204 includes the nonlinear tapered structure. More particularly, in the embodiments depicted in FIGS. 2I-2J, the non-linear tapered structure for the transition region 210 is provided by sidewalls 211 that have a convex curvature, as depicted in FIG. 2C. More particularly, the curvature (a) for the sidewalls 211 depicted FIG. 2C can also be characterized as being less than 1, e.g., α<1. The transition region 210 including the non-linear tapered structure with sidewalls 211 that have a convex curvature (as depicted in FIG. 2C) is positioned in the first material layer 209 of the bidirectional grating coupler structure 280 that is depicted in FIG. 2I. In the embodiment that is depicted in FIG. 2I, the second material layer 221 includes the transition region that is linear. In some embodiments, the transition region 210 within the second material layer 221 has planar sidewalls that can be characterized as α=1.

The method described above for forming the multilayered optical device depicted in FIGS. 2C-2H is suitable for forming the embodiment depicted in FIGS. 21 and 2J. More specifically, the process steps described in FIGS. 2D, 2E and 2G are suitable for forming the structures depicted in FIGS. 21 and 2J. The process step described in FIG. 2E can provide the first material layer 209 that is depicted in FIGS. 21 and 2J, in which the mask for patterning the geometry of the first material layer 209 is selected to provide the geometry depicted in FIG. 2C. FIG. 2C illustrates an embodiment of a transition region 210 having sidewalls 211 with a convex curvature that provides the taper between the grating structure portion 293 and the waveguide portion 215. The process step described in FIG. 2G can provide the second material layer 221 that is depicted in FIGS. 21 and 2J, in which the mask for patterning the geometry of the second material layer 221 is selected to provide a linear transition region 210, in which the sidewalls can be characterized as α=1.

FIG. 2I is a top down view illustrating a multilayered grating coupler structure 280 including a first material layer 209 having a transition region 210 that is tapered with a convex curvature between the grating structure portion 293 and the waveguide portion 215 (as seen in FIG. 2C), and a second material layer 221 having a transition region 210 that is linear between the grating structure portion 293 and the waveguide portion 215. The second material layer 221 is present over the first material layer 209, in which the second material layer 221 receives the optical signal before the first material layer 209. The first material layer 209 includes the non-linear tapered transition, in which a portion of the curvature from the transition region 210 is integrated with the grating structure portion 293. The second material layer 221 does not include a curvature for tapering in the transition region 210.

FIG. 2J also illustrates transmission of optical signal from a first side to the second side of the multilayered grating coupler structure. The optical signal 274 received from an optical fiber 905 (as seen in FIG. 9) is first received by the grating structure of the second material layer 221 of the bidirectional grating coupler structure 280. A portion of the optical signal 274 is coupled with the second material layer 221 in the grating coupler portion and transmitted as first coupled optical signal 276. A portion of the optical signal 274 that is not coupled with the second material layer 221 is transmitted to the lower first material layer 209 and/or is reflected off the mirror layer 260 as non-coupled optical signal 275. The non-coupled optical signal 275 may be reflected off the mirror layer 260 as reflected optical signal 277. The reflected optical signal 277 may couple with the first material layer 209 as coupled reflected optical signal 281. Further, the first coupled optical signal 276 in the second material layer 221 may also be transmitted to the first material layer 209 as transferred optical signal 279. The coupled reflected optical signal 281 and the transferred optical signal 279 from the second material layer 221 may exit the grating coupler portion through the transition region in the first material layer 209. The transition region in the first material layer 209 includes the non-linear tapered transition including a convex curvature (α<1), whereas the transition region in the second material layer 221 is linear (α=1). The non-linear tapered transition effectively reduces the transmission losses in waveguide transitions and improves optical coupling efficiency. The reduction in transmission losses and improved coupling efficiency can be apparent when comparing the transition region in the first material layer 209 including the non-linear tapered transition having sidewalls with a convex curvature (as depicted in FIG. 2C) to the transition region in the second material layer 221 that is linear. The outlet of the first material layer 221 does not include the majority of the optical signal between transmitted from the transition region 210 due to transmission loss that can occur therein.

FIGS. 2K and 2L illustrate another embodiment of a multilayered grating coupler 204, in which at least both layers of the multilayered grating coupler 204 include the nonlinear tapered structure. More particularly, in the embodiments depicted in FIGS. 2K-2L, the non-linear tapered structure for the transition region 210 is present in both the first material layer 209 and the second material layer 221.

For example, in the first material layer 209 the nonlinear tapered structure is provided by sidewalls 211 that have a convex curvature, as depicted in FIG. 2C. More particularly, the curvature (a) for the sidewalls 211 depicted FIG. 2C can also be characterized as being less than 1, e.g., α<1. The transition region 210 for the first material layer 209 includes the non-linear tapered structure with sidewalls 211 that have a convex curvature (as depicted in FIG. 2C).

For example, in the second material layer 221 the nonlinear tapered structure is provided by sidewalls 211 that have a concave curvature, as depicted in FIG. 2B. More particularly, the curvature (a) for the sidewalls 211 depicted FIG. 2B can also be characterized as greater less than 1, e.g., α>1. The transition region 210 for the second material layer 221 includes the non-linear tapered structure with sidewalls 211 that have a concave curvature (as depicted in FIG. 2B).

The method described above for forming the multilayered optical device depicted in FIGS. 2C-His suitable for forming the embodiment depicted in FIGS. 2K and 2L. More specifically, the process steps described in FIGS. 2D, 2E and 2G is suitable for forming the structures depicted in FIGS. 2K and 2L. The process step described in FIG. 2E can provide the first material layer 209 that is depicted in FIGS. 2K and 2L, in which the mask for patterning the geometry of the first material layer 209 is selected to provide the geometry depicted in FIG. 2C. FIG. 2C illustrates an embodiment of a transition region 210 having sidewalls 211 with a convex curvature that provides the taper between the grating structure 293 and the waveguide portion 215. The process step described in FIG. 2G can provide the second material layer 221 that is depicted in FIGS. 2K and 2L, in which the mask for patterning the geometry of the second material layer 221 is selected to provide the geometry depicted in FIG. 2B. FIG. 2B illustrates an embodiment of a transition region 210 having sidewalls 211 with a concave curvature that provides the taper between the grating structure 293 and the waveguide portion 215.

FIG. 2K is a top down view illustrating a multilayered grating coupler structure 280 including a first material layer 209 having a tapered transition with a convex curvature between the grating structure portion 293 and the waveguide portion 215 (as seen in FIG. 2C), and a second material layer 221 having a tapered transition with a concave curvature between the grating structure portion 293 and the waveguide portion 215 (as seen in FIG. 2B). The second material layer 221 is present over the first material layer 209, in which the second material layer 221 receives the optical signal before the first material layer 209.

FIG. 2L illustrates transmission of optical energy from a first side to the second side of the multilayered grating coupler structure. The optical signal 274 received from an optical fiber 905 (as seen in FIG. 9) is first received by the grating structure of the second material layer 221 of the bidirectional grating coupler structure 280. A portion of the optical signal 274 is coupled with the second material layer 221 in the grating coupler portion and transmitted as first coupled optical signal 276. A portion of the optical signal 274 that is not coupled with the second material layer 221 is transmitted to the lower first material layer 209 and/or is reflected off the mirror layer 260 as non-coupled optical signal 275. The non-coupled optical signal 275 may be reflected off the mirror layer 260 as reflected optical signal 277. The reflected optical signal 277 may couple with the first material layer 209 as coupled reflected optical signal 281. Further, the first coupled optical signal 276 in the second material layer 221 may also be transmitted to the first material layer 209 as transferred optical signal 279. The coupled reflected optical signal 281 and the transferred optical signal 279 from the second material layer 221 may exit the grating coupler portion through the transition region in the first material layer 209. The transition region in the first material layer 209 includes the non-linear tapered transition including a convex curvature (α<1), whereas the transition region in the second material layer 221 includes the non-linear tapered transition including a concave curvature (α>1).

FIGS. 3-9 illustrate formation of an optical package integrating the grating coupler 204 as described above with reference to FIGS. 2A-2L. Each of the embodiments depicted in FIGS. 2A-2L may be integrated into the optical package described with reference to FIGS. 3-9. For simplicity, the different embodiments for the grating couplers depicted in FIGS. 2A-2L may collectively be depicted by the structure having reference number 204 in FIGS. 3-9. In some embodiments, prior to processing to integrate the grating coupler 204 into an optical package, any masking structures, e.g., hard masks and/or photoresist masks, used to isolate the grating coupler portion 205 of the interposer 100 during forming the grating coupler 204 may be removed.

FIG. 3 illustrates that, for those components that utilize further manufacturing processes, such as Mach-Zehnder silicon-photonic switches that utilize resistive heating elements, additional processing may be performed either before or after the patterning of the material for the first active layer 201 for forming the first optical components and/or either before or after forming the grating coupler 204. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

FIG. 4 illustrates that, once the grating coupler 204 and the first optical components 203 have been formed, a second insulator layer 401 may be deposited to cover the grating coupler 204 and the first optical components 203. The second insulator layer 401 may provide additional cladding material. In an embodiment the second insulator layer 401 may be a dielectric layer that separates the individual components of the first active layer 201 from each other and from the overlying structures and can additionally serve as another portion of cladding material that surrounds the first optical components 203 and the grating coupler 204. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203 and the grating coupler 204) or else planarize the second insulator layer 401 with top surfaces of the first optical components 203 and the grating coupler 204. However, any suitable material and method of manufacture may be used.

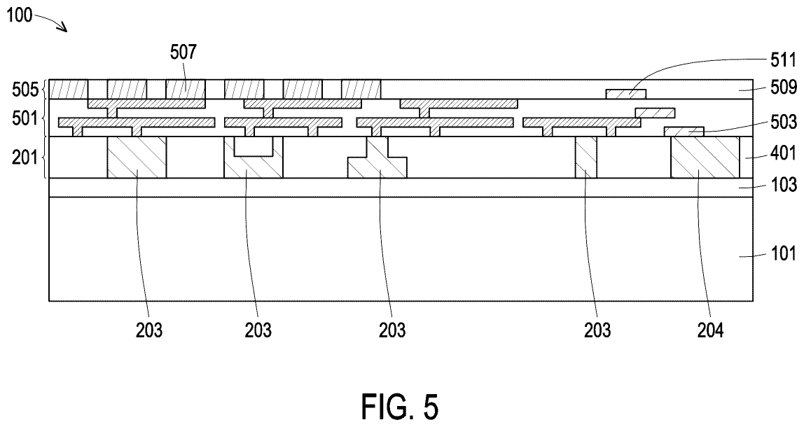

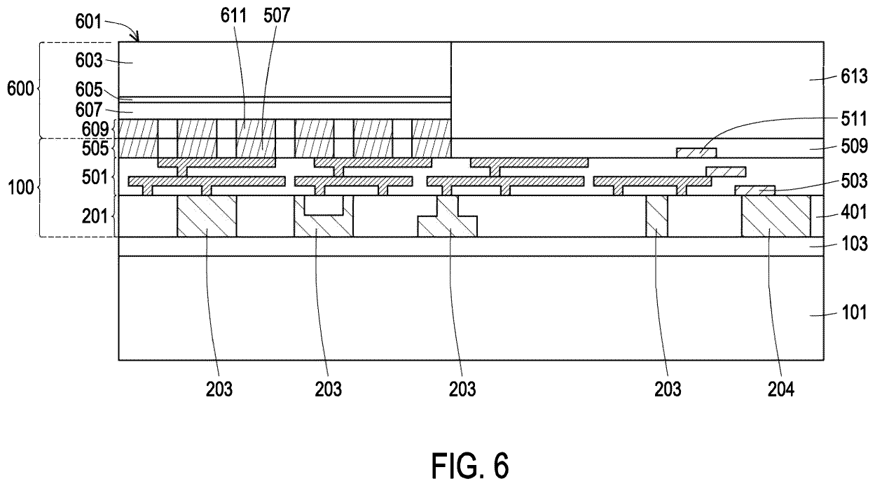

FIG. 5 illustrates that, once the first optical components 203 and the grating coupler 204 have been manufactured and the second insulator layer 401 has been formed, first metallization layers 501 are formed in order to electrically connect the first active layer 201 of first optical components 203 and the grating coupler 204 to control circuitry, to each other, and to subsequently attached devices (not illustrated in FIG. 5 but illustrated and described further below with respect to FIG. 6). In an embodiment the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, as well as the grating coupler 204, but the precise number of first metallization layers 501 is dependent upon the design of the optical interposer 100.

Additionally, during the manufacture of the first metallization layers 501, one or more second optical components 503 may be formed as part of the first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503. In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, and can be utilized to help further the manufacturing of the various desired one or more second optical components 503. All such manufacturing processes and all suitable one or more second optical components 503 may be manufactured, and all such combinations are fully intended to be included within the scope of the embodiments.

Once the one or more second optical components 503 of the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 509 such as silicon oxide, silicon nitride, or the like. The first dielectric material 509 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 509 are formed to expose conductive portions of the underlying layers in preparation to form first bond pads 507 within the first bonding layer 505. Once the first openings have been formed within the first dielectric material 509, the first openings may be filled with a seed layer and a plate metal to form the first bond pads 507 within the first dielectric material 509. The seed layer may be blanket deposited over top surfaces of the first dielectric material 509 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 509 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 509, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 6 illustrates a bonding of a first semiconductor device 601 to the first bonding layer 505 of the optical interposer 100. In some embodiments, the first semiconductor device 601 is an electronic integrated circuit (EIC—e.g., a device without optical devices) and may have a semiconductor substrate 603, a layer of active devices 605, an overlying interconnect structure 607, a second bonding layer 609, and associated third bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the third bond pads 611 may be similar to the first bond pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H2, exposure to N2, exposure to O2, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are subjected to thermal treatment and contact pressure to bond the optical interposer 100 and a laser die 600. For example, the optical interposer 100 and the first semiconductor device 601 may be subjected to a pressure of about 200 kPa or less, and a temperature between about 25° C. and about 250° C. to fuse the optical interposer 100 and the first semiconductor device 601. The optical interposer 100 and the first semiconductor device 601 may then be subjected to a temperature at or above the eutectic point for material of the first bond pads 507 and the third bond pads 611, e.g., between about 150° C. and about 650° C., to fuse the metal. In this manner, the optical interposer 100 and the first semiconductor device 601 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6 additionally illustrates that, once the first semiconductor device 601 has been bonded, a second gap-fill material 613 is deposited in order to fill the space around the first semiconductor device 601 and provide additional support. In an embodiment the second gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the second gap-fill material 613 has been deposited, the second gap-fill material 613 may be planarized in order to expose the first semiconductor device 601. In an embodiment the planarization process may be a chemical mechanical planarization process, a grinding process, or the like. However, any suitable planarization process may be utilized.

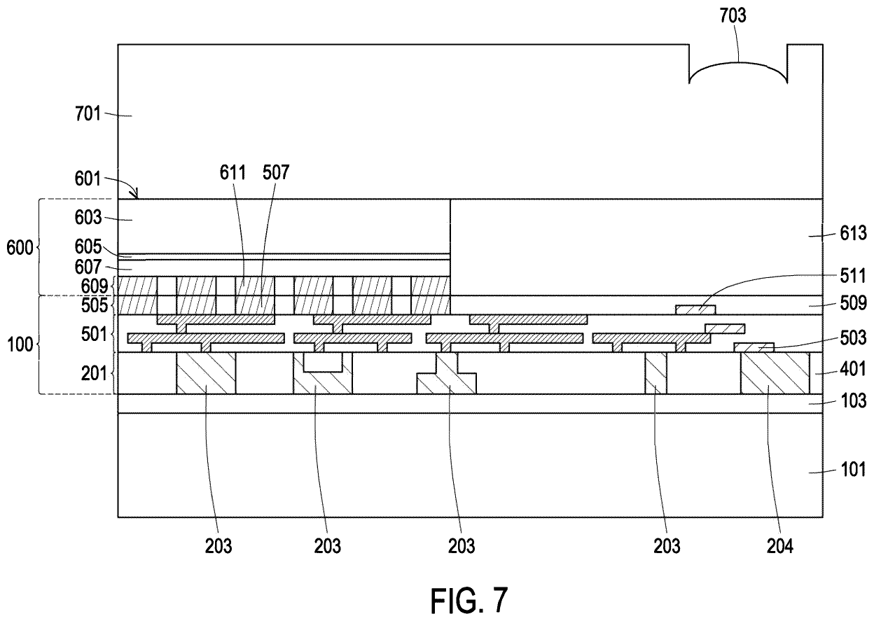

FIG. 7 illustrates an attachment of a support substrate 701 to the first semiconductor device 601 and the second gap-fill material 613. In an embodiment the support substrate 701 may be a support material that is transparent to the wavelength of light that is desired to be used, such as silicon, and may be attached using, e.g., an adhesive (not separately illustrated in FIG. 7). However, in other embodiments the support substrate 701 may be bonded to the first semiconductor device 601 and the second gap-fill material 613 using, e.g., a bonding process. Any suitable method of attaching the support substrate 701 may be used.

FIG. 7 additionally illustrates the support substrate 701 comprises a coupling lens 703 positioned to facilitate movement from an optical fiber 905 (not illustrated in FIG. 7 but illustrated and described further below with respect to FIG. 9) to the grating coupler 204, the second optical components 503 of the first metallization layers 501, or the third optical components 511. In an embodiment the coupling lens 703 may be formed by shaping the material of the support substrate (e.g., silicon) using masking and etching processes. However, any suitable process may be utilized.

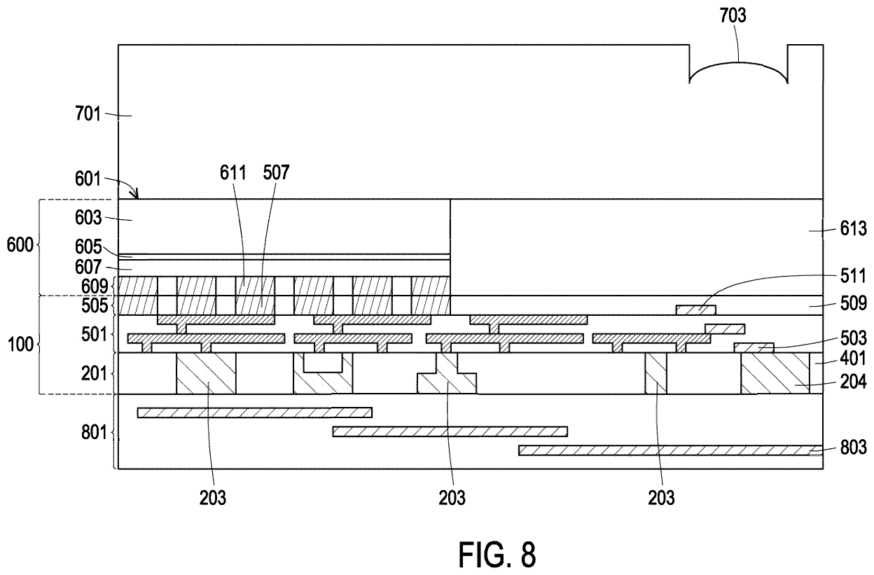

FIG. 8 illustrates a removal of the first substrate 101 and, optionally, the first insulator layer 103, thereby exposing the first active layer 201 of first optical components 203 and the grating coupler 204. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

FIG. 9 illustrates formation of first through device vias (TDVs) 901, formation of a third bonding layer 903, and placement of an optical fiber 905 to form a first optical package 900. In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first bond pads 507) and even fifth optical components 911 (similar to the third optical components 511). However, any suitable devices may be utilized.

Optionally at this point in the process, an optical fiber 905 may be attached. In an embodiment the optical fiber 905 is utilized as an optical input/output port to the optical interposer 100. In an embodiment the optical fiber 905 is placed so as to optically couple the optical fiber 905 and an optical input such as a grating coupler (not separately illustrated in FIG. 9) that is part of the first optical components 203, the second optical components 503, or the third optical components 511. By positioning the optical fiber 905 as such, optical signals leaving the optical fiber 905 are directed towards, e.g., the first active layer 201 of first optical components 203 and the grating coupler 204. Similarly, the optical fiber 905 is positioned so that optical signals leaving the first active layer 201 of first optical components 203 is directed into the optical fiber 905 for transmission. However, any suitable location may be utilized.

The optical fiber 905 may be held in place using, e.g., an optical glue 907. In some embodiments, the optical glue 907 comprises a polymer material such as epoxy-acrylate oligomers, and may have a refractive index between about 1 and about 3. However, any suitable material may be utilized.

Additionally, while the optical fiber 905 is illustrated as being attached at this point in the manufacturing process, this is intended to be illustrative and is not intended to be limiting. Rather, the optical fiber 905 may be attached at any suitable point in the process. Any suitable point of attachment may be utilized, and all such attachments at any point in the process are fully intended to be included within the scope of the embodiments.

By utilizing the structures and methods presented herein, nonlinear designs are employed in the transition region between the grating structure and a waveguide that can effectively reduce transmission losses in waveguide transitions and improve optical coupling efficiency. In some embodiments, the nonlinear gradient structures can reduce instability during waveguide width convergence, avoiding additional losses and reflections. In some embodiments, the nonlinear design has strong application advantages and can be applied in multi-layer structures to reduce switching losses between layers and improve overall optical performance. Nonlinear gradient structures can integrate components of different sizes and modes, achieving optical coupling between components. In some embodiments, the non-linear taper designs provide a transition to converge light into the main transmission layer waveguide in a multilayer optical device structure, such as an optical device that includes a multilayer grating coupler.

In some embodiments, a method of forming an optical device is provided that includes forming an optical signal coupling material layer including at least one set of gratings on a cladding layer, and patterning the optical signal coupling material layer to provide a geometry including a grating structure including the at least one set of gratings and a waveguide, wherein transition region including a curved sidewall is present between the grating structure and the waveguide. In some embodiments, the curved sidewall for the transition region begins at an end grating in the at least one set of gratings at an interface of the grating structure and the transition region. In some embodiments, the curved sidewall of the transition region is concave relative to a centerline running down a length of the grating structure, the transition region and the waveguide. In some embodiments, the curved sidewall of the transition region is convex relative to a centerline running down a length of the grating structure, the transition region and the waveguide. In some embodiments, the multilayered structure includes a first material layer on the cladding layer, and a second material layer in the first material layer. At least one set of gratings includes a first set of gratings extending in a first direction away from a base of the first material layer and a second set of gratings extending in a second direction away from an upper surface of the second material layer, wherein the first set of gratings having the first direction and the second set of gratings having the second direction provide a bidirectional grating structure. In some embodiments, the optical signal coupling material layer is a multilayered structure, and forming the optical signal coupling material layer includes forming a first material layer that is formed on the cladding layer; patterning the first material layer to include a linear transition region; and forming a second material layer on the first material layer, wherein the second material layer that is formed on the first material layer, wherein the patterning of the optical signal coupling material layer comprises patterning the second material layer to provide the geometry including the grating structure including the at least one set of gratings and the waveguide, wherein the transition region including the curved sidewall is present between the grating structure and the waveguide. In some embodiments, the curved sidewall has a concave curvature. In some embodiments, the optical signal coupling material layer is a multilayered structure, and forming the optical signal coupling material layer includes forming a first material layer that is formed on the cladding layer, wherein the patterning of the optical signal coupling material layer comprises patterning the first material layer to provide the geometry including the grating structure including the at least one set of gratings and the waveguide, wherein the transition region including the curved sidewall is present between the grating structure and the waveguide. In some embodiments, forming the optical signal coupling material further includes forming a second material layer on the first material layer, and patterning the first material layer to include a linear transition region. In some embodiments, the curved sidewall has a convex curvature. In some embodiments, the optical signal; coupling material layer is a multilayered structure, and wherein the forming of the optical signal coupling material layer comprises forming a first material layer that is formed on the cladding layer, wherein the patterning of the optical signal coupling material layer comprises patterning the first material layer to provide the geometry including the grating structure including the at least one set of gratings and the waveguide, the transition region including the curved sidewall is present between the grating structure and the waveguide, the curved sidewall having a first curvature type, forming a second material layer on the first material layer, and patterning the second material layer to include a tapered transition region having a second curvature type sidewall. In some embodiments, the first curvature type for the curved sidewall in the transition region of the first material layer is convex, and the second curvature type sidewall for tapered transition region in the second material layer is concave.

In another embodiment, an optical device comprising a cladding layer; and an optical signal coupling material layer on the cladding layer, the optical signal coupling material layer including a grating structure including the at least one set of gratings and a waveguide, wherein transition region including a sidewall having a concave curvature that is present between the grating structure and the waveguide. In some embodiments, the optical signal coupling material layer is a multilayered structure. In some embodiments, the multilayered structure includes a first material layer on the cladding layer, and a second material layer in the first material layer, wherein the at least one set of gratings includes a first set of gratings extending in a first direction away from a base of the first material layer and a second set of gratings extending in a second direction away from an upper surface of the second material layer, wherein the first set of gratings having the first direction and the second set of gratings having a second direction provide a bidirectional grating structure. In some embodiments, the multilayered structure for the optical signal coupling material layer includes a first material layer on the cladding layer, and a second material layer on the first material layer, wherein the first material layer includes a linear transition region, and the second material layer includes the grating structure including the at least one set of gratings, the waveguide and the transition region curved sidewall having the concave curvature. In some embodiments, the multilayered structure for the optical signal coupling material layer includes a first material layer on the cladding layer, and a second material layer on the first material layer, wherein the first material layer includes the grating structure, the waveguide, and the transition region including the sidewall having a concave curvature that is present between the grating structure and the waveguide, and the second material layer includes a tapered transition region having a convex curvature type sidewall.

In another embodiment, an optical device comprising a cladding layer; and an optical signal coupling material layer on the cladding layer, the optical signal coupling material layer including a grating structure including the at least one set of gratings and a waveguide, wherein transition region including a sidewall having a convex curvature that is present between the grating structure and the waveguide. In some embodiments, the optical signal coupling material layer is a multilayered structure. In some embodiments, the optical signal coupling material layer is a multilayered structure of a first material layer on the cladding layer, and a second material layer in the first material layer, wherein the at least one set of gratings includes a first set of gratings extending in a first direction away from a base of the first material layer and a second set of gratings extending in a second direction away from an upper surface of the second material layer, wherein the first set of gratings having the first direction and the second set of gratings having a second direction provide a bidirectional grating structure. In some embodiments, the multilayered structure for the optical signal coupling material layer includes a first material layer on the cladding layer, and a second material layer on the first material layer, wherein the first material layer includes a tapered transition region having a concave curvature type sidewall, and the second material layer includes the grating structure, the waveguide, and the transition region including the sidewall having the convex curvature that is present between the grating structure and the waveguide.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of forming an optical device comprising:
forming an optical signal coupling material layer on a cladding layer; and
patterning the optical signal coupling material layer to provide a geometry including a grating structure including at least one set of gratings and a waveguide, wherein a transition region includes a curved sidewall present between the grating structure and the waveguide.

2. The method of claim 1, wherein the curved sidewall for the transition region begins at an end grating in the at least one set of gratings at an interface of the grating structure and the transition region.

3. The method of claim 1, wherein the curved sidewall of the transition region is concave relative to a centerline running down a length of the grating structure, the transition region and the waveguide.

4. The method of claim 1, wherein the curved sidewall of the transition region is convex relative to a centerline running down a length of the grating structure, the transition region and the waveguide.

5. The method of claim 1, wherein a multilayered structure includes a first material layer on the cladding layer, and a second material layer in the first material layer, wherein the at least one set of gratings includes a first set of gratings extending in a first direction away from a base of the first material layer and a second set of gratings extending in a second direction away from an upper surface of the second material layer.

6. The method of claim 1, wherein the optical signal coupling material layer is a multilayered structure, and wherein the forming of the optical signal coupling material layer comprises:
forming a first material layer that is formed on the cladding layer;
patterning the first material layer to include a linear transition region; and
forming a second material layer on the first material layer, wherein the patterning of the optical signal coupling material layer comprises:
patterning the second material layer to provide the geometry including the grating structure including the at least one set of gratings and the waveguide, wherein the transition region including the curved sidewall is present between the grating structure and the waveguide.

7. The method of claim 6, wherein the curved sidewall has a concave curvature.

8. The method of claim 1, wherein the optical signal coupling material layer is a multilayered structure, and wherein the forming of the optical signal coupling material layer comprises:
forming a first material layer on the cladding layer, wherein the patterning of the optical signal coupling material layer comprises patterning the first material layer to provide the geometry including the grating structure including the at least one set of gratings and the waveguide, wherein the transition region including the curved sidewall is present between the grating structure and the waveguide;
forming a second material layer on the first material layer; and
patterning the first material layer to include a linear transition region.

9. The method of claim 8, wherein the curved sidewall has a convex curvature.

10. The method of claim 1, wherein the optical signal coupling material layer is a multilayered structure, and wherein the forming of the optical signal coupling material layer comprises:
forming a first material layer that is formed on the cladding layer, wherein the patterning of the optical signal coupling material layer comprises patterning the first material layer to provide the geometry including the grating structure including the at least one set of gratings and the waveguide, the transition region including the curved sidewall is present between the grating structure and the waveguide, the curved sidewall having a first curvature type;
forming a second material layer on the first material layer; and
patterning the second material layer to include a tapered transition region having a second curvature type sidewall different from the first curvature type.

11. The method of claim 10, wherein the first curvature type is convex, and the second curvature type sidewall is concave.

12. An optical device comprising:
a cladding layer; and
an optical signal coupling material layer on the cladding layer, the optical signal coupling material layer including a grating structure including the at least one set of gratings and a waveguide, wherein a transition region includes a sidewall having a concave curvature that is present between the grating structure and the waveguide.

13. The optical device of claim 12, wherein the optical signal coupling material layer is a multilayered structure.

14. The optical device of claim 13, wherein the multilayered structure includes a first material layer on the cladding layer, and a second material layer in the first material layer, wherein the at least one set of gratings includes a first set of gratings extending in a first direction away from a base of the first material layer and a second set of gratings extending in a second direction away from an upper surface of the second material layer, wherein the first set of gratings having the first direction and the second set of gratings having a second direction provide a bidirectional grating structure.

15. The optical device of claim 13, wherein the multilayered structure includes a first material layer on the cladding layer, and a second material layer on the first material layer, wherein the first material layer includes a linear transition region, and the second material layer includes the grating structure including the at least one set of gratings, the waveguide and the transition region with the sidewall having the concave curvature.

16. The optical device of claim 13, wherein the multilayered structure for the optical signal coupling material layer includes a first material layer on the cladding layer, and a second material layer on the first material layer, wherein the first material layer includes the grating structure, the waveguide, and the transition region including the sidewall having a concave curvature that is present between the grating structure and the waveguide, and the second material layer includes a tapered transition region having a convex curvature type sidewall.

17. An optical device comprising:
a cladding layer; and
an optical signal coupling material layer on the cladding layer, the optical signal coupling material layer including a grating structure including the at least one set of gratings and a waveguide, wherein a transition region includes a sidewall having a convex curvature that is present between the grating structure and the waveguide.

18. The optical device of claim 17, wherein the optical signal coupling material layer is a multilayered structure.

19. The optical device of claim 18, wherein the optical signal coupling material layer is a multilayered structure of a first material layer on the cladding layer, and a second material layer in the first material layer, wherein the at least one set of gratings includes a first set of gratings extending in a first direction away from a base of the first material layer and a second set of gratings extending in a second direction away from an upper surface of the second material layer, wherein the first set of gratings having the first direction and the second set of gratings having a second direction provide a bidirectional grating structure.

20. The optical device of claim 18, wherein the multilayered structure for the optical signal coupling material layer includes a first material layer on the cladding layer, and a second material layer on the first material layer, wherein the first material layer includes a tapered transition region having the convex curvature that is present between the grating structure and the waveguide, and the second material layer includes a concave curvature type sidewall.
